(19) United States
(12) Patent Application Publication
(10) Pub. No.: US 2017/0273856 A1
(43) Pub. Date: Sep. 28, 2017

(54) COPPER MASSAGER THERAPY TOOL

(71) Applicant: Jeffrey David Lynch, Raleigh, NC (US)

(72) Inventor: Jeffrey David Lynch, Raleigh, NC (US)

(73) Assignee: Jeffrey David Lynch, Raleigh, NC (US)

(21) Appl. No.: 15/465,767

(22) Filed: Mar. 22, 2017

Related U.S. Application Data
(60) Provisional application No. 62/313,782, filed on Mar. 27, 2016.

(51) Int. Cl. A61H 7/00

(52) U.S. Cl. CPC A61H 7/003; A61H 2201/0207; A61H 2201/0214

(57) ABSTRACT

A hand held massage tool that is used for the therapy of muscles and tendons that are suffering from tightness, knots and overall soreness. It can be used as a preventative measure to help keep muscles and tendons stretched. Treatment includes a rubbing back and forth and rolling motion by the copper massage tool directly on the muscle and tendon area that is being focused on. The massage tool is comprised of copper tubing that is filled with liquid to provide the benefit of a thermal transfer of hot and cold properties achieved by the liquid from inside and around the outside of the copper tube for massage therapy treatments. The copper tube generates heat by friction and is also heated and cooled by external sources.

This application claims the benefit of U.S. Provisional Application No. 62313782, filed Mar. 27, 2016.

### BACKGROUND

Field of the Invention

This invention relates to the field of tools used in massage and physical therapy.

Description of the Related Art

There are many known tools used in massage and physical therapy to assist in providing relief from muscle tightness, soreness and overuse of muscle injuries. One good example is a hand held plastic roller stick that is rolled across muscles to massage out tightness with pressure being applied by the tool to roll out various muscles and tendons for the relief of muscle knots; lactic acid and scar tissue build up. Many runners and athletes of different sports rely upon the use of these types of tools to self-massage muscle and tendon areas as a preventative measure of muscle tightness as well as the therapeutic usage for the relief and rehabilitation caused by overuse injuries, muscle tightness and soreness.

### SUMMARY

The present invention comprises of a hand held massage tool that is constructed of copper and is of a round tubular in shape. It has hand grips located at each end of the tube. Inside the tube or “pipe” contains liquid that has thermal liquid transfer properties to help better distribute heat evenly throughout the tube that has been generated by either friction from the movement of the tool against the skin or from external warming by other means. The liquid also provides the same thermal transfer benefits for cold by means of externally freezing the massage tool. Propylene Glycol is a type of liquid used inside the tube as this form of liquid has known liquid thermal transfer properties. The ends of the tube are plugged so that the liquid cannot leak out. The copper massage tool can be self-administered or used by a massage or physical therapist to apply a rubbing back and forth or rolling motion against the muscle area being treated. A main feature of the massage tool is that it allows for heat and cold therapies to be administered.

### BRIEF DESCRIPTION OF THE DRAWINGS

FIG. 1 is a perspective view, showing the present invention.

FIG. 2 is an exploded perspective view, showing all of the parts.

FIG. 3 is a cross sectional side view, showing all parts assembled.

FIG. 4 is an end cross sectional view.

### REFERENCE NUMERALS IN THE DRAWINGS

10. HAND GRIP

12. COPPER TUBE, “PIPE”

14.TUBE PLUG/CAP

16. THERMAL TRANSFER LIQUID, i.e. PROPYLENE GLYCOL

### DETAILED DESCRIPTION

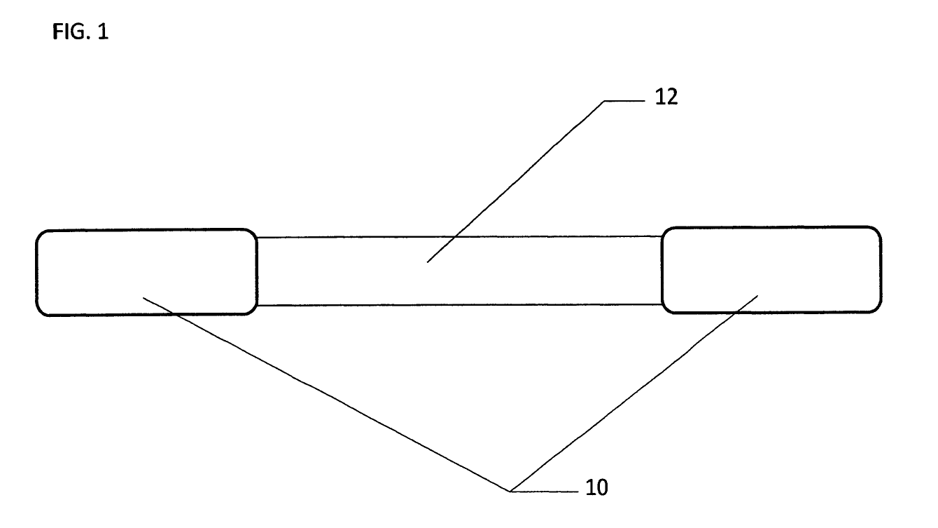

FIG. 1 shows a perspective view of the invention in the assembled state. The copper massage tool is used by holding onto it by the hand grip 10 and with a back and forth motion rubbing the copper tube 12 against the targeted muscle area. The back in forth motion of the copper tube 12 with pressure applied to help smooth out a muscle and tendons from tightness and to also provide relief of soreness that is typically caused by overuse of the muscle or tendons. The thermal transfer liquid 16 inside the copper tube 12 assists in the distribution of heat throughout the tool that is generated by friction from the back and forth motion and pressure against the targeted massaged skin area. The invention can also be externally heated by a heating blanket or other means to provide additional heated therapy for the massage. The invention can also provide a cold therapy massage by first freezing the invention, such as in the freezer. The freezing of the copper tube 12 will turn the internal thermal transfer liquid 16 into a slushy and frozen mixture for the purpose of providing a period of time to administer a cold therapy massage.

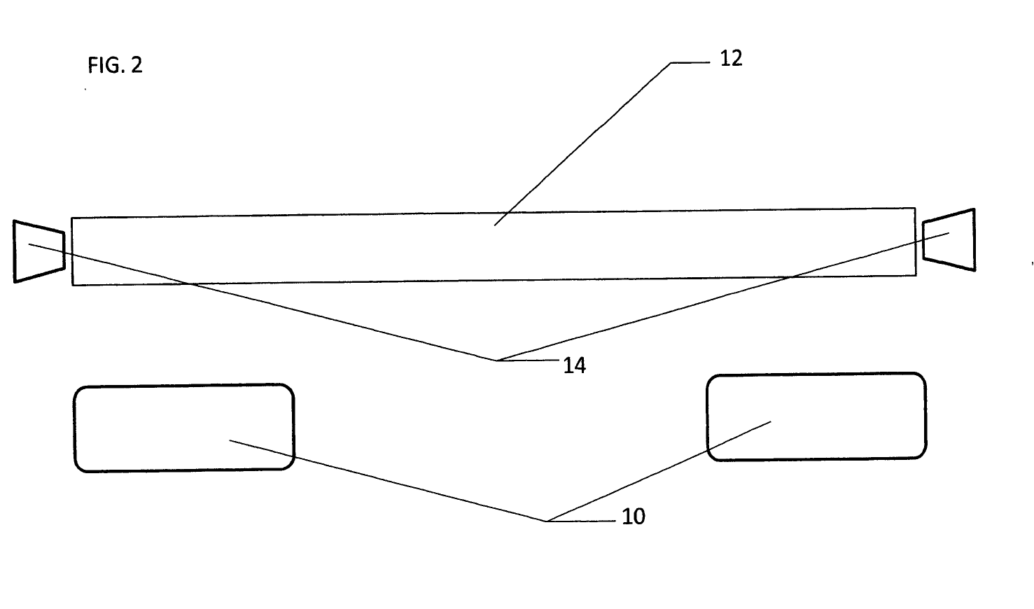

FIG. 2 shows an exploded unassembled view of all components of the invention with the exception of the thermal transfer liquid 16. The assembly consists of plugging one end of the tube 12 with a tube plug 14. Fill the copper tube 12 with a desired amount of thermal transfer liquid 16, then plugging the other end of the tube 12 with another tube plug 14. Place a hand grip 10 on each end of the copper tube 12 and the assembly is complete.

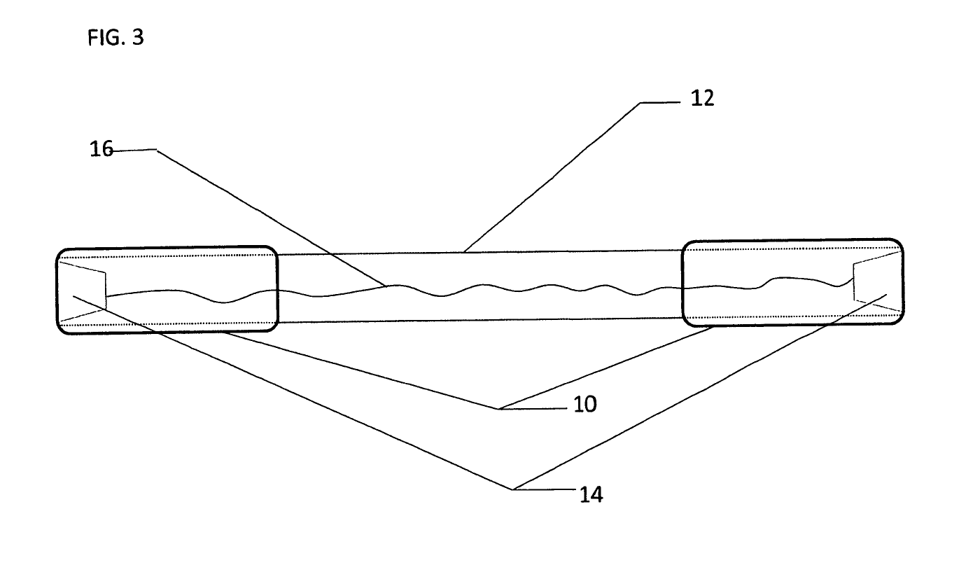

FIG. 3 shows a side cross section of all components of the invention. The thermal transfer liquid 16 is shown inside the copper tube 12.

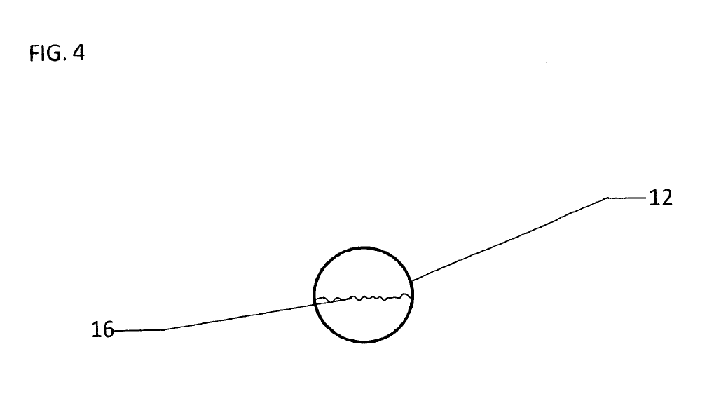

FIG. 4 shows an end cross section view of copper tube 12 to give the perspective that the tube is round and tubular that holes the thermal transfer liquid 16.

Although the preceding description contains significant detail, it should not be construed as limiting the scope of the invention but rather as providing illustrations of the preferred embodiments of the invention. As an example, copper tube 12 could vary in size by length and width and also include variations of the tubular shape with different textures or raised nodules on the exterior. The copper tube 12 could also rotate by means of using different hand grips 10 to allow for the rotation of the copper tube 12 as it is applied in a back and forth motion during the massage. The thermal transfer liquid 16 should not be restricted to only Propylene Glycol as other liquid types are comparable. Such a variation would not materially alter the nature of the invention. Thus, the scope of the invention should be fixed by the following claims rather than any specific examples provided

1. A hand held copper massage therapy tool which provides friction heat generating and cold therapy applications for the treatment of muscles and tendon tension. The tool comprises of:
a. Copper tube
b. Hand grips
c. Liquid inside the sealed copper tube

2. A copper massage therapy tool as cited in claim 1, wherein copper tube is used directly on the skin in a back and forth or rolling motion.

3. A copper massage therapy tool as cited in claim 1, wherein hand grips are used for holding the tool to apply pressure and massaging.

4. A copper massage therapy tool as cited in claim 1, wherein thermal liquid inside the copper tube, i.e. Propylene Glycol to assist in the distribution of heat caused by friction. The thermal properties of the liquid and copper tube also assist in the distribution of hot and cold properties that are externally sourced.
